(19) United States
(12) Patent Application Publication
(10) Pub. No.: US 2001/0013188 A1
(43) Pub. Date: Aug. 16, 2001

(54) COLLAPSIBLE DECORATIVE FIGURES

(76) Inventor: WILLIAM G. HALL, FLORENCE, KY (US)

Correspondence Address: R CHRISTIAN MACKE, 40 EAST 10TH STREET, NEWPORT, KY, 41071

(21) Appl. No.: 09/024,887

(22) Filed: Feb. 17, 1998

(51) Int. Cl. G09F 15/00

(52) U.S. Cl. 40/610

(57) ABSTRACT

Collapsible decorative figures comprising multiple interconnected sections. Locking and folding provisions are provided on each decorative figure so that no disassembly is required to collapse the figures. Several embodiments collapse into a box for storage when not in use. One embodiment is a multiple figure display wherein one of the figures collapses into a box in which the other decorative figures of the display, when collapsed, are stored.

### TECHNICAL FIELD

The present invention relates to decorative figures of the type displayed in and around residential homes, often during holiday seasons, specifically including decorative figures that are collapsible.

### BACKGROUND OF THE INVENTION

It has long been a practice for families to decorate their homes with seasonal ornaments, adornments, figures and other similar displays. These decorations are most prevalent during the Christmas holiday season, although there are similar decorative adornments on other holidays, including Halloween and Thanksgiving. Examples of Christmas displays include depictions of religious themes, such as nativity scenes centered around the birth of Jesus Christ, displays of angels, Christmas wreaths and the like, while other displays featuring mythological or folk based figures, such as Santa Claus with sleigh and flying reindeer, Frosty the Snowman, Christmas trees and toy trains and soldiers, are also popular.

Displays of these religious and mythological figures take on many functional forms, such as hanging attachment to a house or building, as well as erection of self standing figures on a lawn, porch or roof. An objective of any display of this type is to decorate the home or building in a festive manner that is visible to passersby from a distance. It is an important characteristic of the figures, ornaments and adornments that they are large enough to be visible to passersby from a distance, such as those driving by in a car or walking down a sidewalk in view of the house or building.

A typical display of Santa Claus with sleigh and reindeer may be displayed on a porch or lawn, or even on the roof of a home, symbolic of a landing on the roof to deliver presents. However, to be visible to those passersby viewing the display from the street, it is necessary that the figures in such a display be several feet tall. In other Christmas displays, such as a nativity scene featuring a lot of individual elements such as baby Jesus, Mary, Joseph, wisemen, shepherds, animals, a manger, etc., there are many separate figures, and each must be relatively large, i.e. several feet tall, to be visible to passersby.

While home decorations comprising Christmas displays have been discussed heretofore, the principles of the present invention are applicable to other decorative displays, ornaments and adornments. It is specifically contemplated that other holiday decorations comprising large figures intended to be visible to passersby in the street are improved by the principles of the present invention. This includes depictions of witches, pumpkins, ghosts and the like celebrating Halloween; turkeys, Pilgrims and Indians celebrating Thanksgiving; Easter bunny and eggs celebrating Easter; a large stork symbolizing the birth of a child; and any other holiday displays comprising relatively large figures intended to be visible from the street.

The present invention also specifically contemplates the non-holiday decoration of homes, particularly used to adorn landscaped lawns and gardens. Figures such as decorative flower pots, planters, lawn jockeys and other stand alone figures are commonly used and are intended to be visible to passersby to give a more festive appearance. As with the holiday decorations, the objective of visibility to passersby requires that these nonholiday figures be relatively large, several feet tall in most cases.

All of the decorative ornaments, adornments and figures discussed above have the common objective of “dressing up” a home so as to be visible to passersby, which necessarily requires that the ornaments, adornments and figures are large enough to be visible. However, a common problem results from the use of relatively large ornaments, adornments and figures, that being that when they are not in use and are stored in a basement, attic or garage, the large figures occupy a great deal of storage space. This problem is particularly acute in those displays, such as Christmas nativity scenes, that include many separate figures. Also, because it has become common for many homes to have multiple displays (nativity scene, Santa Claus, reindeer, snowman, etc.), the size of the figures becomes more problematic because storage space required necessarily increases.

Another disadvantage of the above described holiday and non-holiday displays including relatively large figures is that of transporting the figures. In the typical case, wherein the figures are displayed for only a short duration of several weeks (such as Christmas displays) and stored away in an attic, basement or garage for the remainder of the year, it is necessary to annually transport the figures from the storage location to the display location. In those displays or combination of displays having many individual figures, many trips are required to manually transport from storage to display and vice versa, given the size, weight and awkwardness of the relatively large figures.

In addition to the aforementioned problems relating to transporting the decorative figures from storage location to display location and vice versa, the size, weight and awkwardness of the relatively large figures are also problematic in the initial transporting and shipping of the packaged figure to the residence. That is, whether the display is delivered to the home or a consumer transports it home from the store himself, the size of the figures makes such transport difficult and often necessitates the use of a truck for transport.

To facilitate transporting of these relatively large figures, and particularly with respect to the initial shipping of the figures, it is common for the figures to be disassembled to reduce overall size and change the packaging dimensions. In such instances, the advantage of shipping a rectangular box of parts is outweighed by the resulting need to provide packing to protect the parts, as well as the considerable burden of assembling, re-assembling, or disassembling the relatively large figures.

Thus, recognizing the problems of transporting and storing the relatively large holiday and non-holiday decorative figures, it is desirable to provide decorative figures that reduce the difficulties encountered in transport and storage and which do not require disassembly or reassembly. Specifically, the present invention solves these problems by adding provisions to decorative figures that make them collapsible into simple geometric shapes that are more easily transported. The simplistic means of collapsing and folding the decorative figures disclosed herein are advantageous in that they allow quick and easy erection into large figures, while minimizing the storage requirements and reducing transportation difficulties. The collapsing and folding provisions of the present invention do not require any disassembly, but rather remain permanently affixed to the figures.

### SUMMARY OF THE INVENTION

The present invention is directed to providing decorative display figures that are large enough to be visible to passersby in the street when erected near a home, as in on the lawn, porch or roof. The principles disclosed herein provide relatively large (several feet tall when fully erected) figures that are collapsible and foldable to make such figures, in the collapsed form, easily and efficiently stored and transported without requiring disassembly or reassembly.

The principles of the present invention are applicable to Christmas decorations such as figures representing Santa Claus, reindeer, snowman, and the like, as shown, as well as to nativity scenes and other Christmas displays. Also, the principles of the present invention applied to other holiday decorations, such as a Halloween witch, Easter bunny, birthday stork, and others, are contemplated by this disclosure such that those or similar figures incorporating the collapsible provisions disclosed herein do not depart from the principles of this invention. Similarly, non-holiday home decorations comprising relatively large figures that include collapsible provisions disclosed herein are contemplated hereby and do not depart from the general principles disclosed herein.

The decorative figures depicted and disclosed herein are advantageous because they are collapsible into a smaller form. They are particularly advantageous, though, because besides being smaller in size when collapsed, the figures fold over onto themselves to create their own carrying boxes that are easily transported and more efficiently stored without requiring any disassembly. That is, the decorative figures of the present invention collapse into rectangular box shaped units that are much smaller and, because of the uniform rectangular shape, less awkward to transport and easier to store. Specifically, each disclosed embodiment of the present invention defines a relatively large figure several feet tall which is collapsible and either forms its own rectangular storage box or fits snugly into a box formed by another collapsed figure.

In a preferred embodiment of the present invention, a decorative Christmas display including figures representing a free-standing Santa Claus, reindeer and sleigh is provided. All three figures include provisions for collapsing and are shaped and sized such that the collapsed Santa Claus figure and collapsed reindeer figure fit snugly within a generally rectangular box formed from the collapsed sleigh.

In another preferred embodiment of the present invention, a free-standing snowman is provided with its own provisions for collapsing into a smaller form. Specifically, the free standing snowman folds over onto itself such that its collapsed form fits into a rectangular box formed from the horizontal base that supports it in the erected form.

Anther preferred embodiment of the present invention provides a planter resembling a mule cart for use in a garden or on a landscaped lawn. The cart includes provisions for collapsing its decorative extensions to form a rectangular box that is easily erected and collapsed and one which is efficiently transported and stored.

### OBJECTS OF INVENTION

It is an object of the present invention to provide relatively large decorative figures that are collapsible into smaller forms.

It is another object of the present invention to provide decorative figures that are efficiently stored when not in use.

It is a further object of the present invention to provide decorative figures that are collapsible into rectangular storage boxes wherein the walls are formed from the figures themselves.

It is still a further object of the present invention to provide decorative holiday displays and figures that are collapsible when not in use to improve storage efficiency during long periods of non-use.

It is another object of the present invention to provide decorative display figures that are collapsible into a smaller form without requiring any disassembly.

It is yet another object of the present invention to provide a decorative display having multiple individual figures, all of which are collapsible into smaller configurations such that they all fit into a rectangular carrying box formed by collapsing one of the figures.

It is another object of the present invention to provide a decorative seasonal holiday display including figures representing a stand alone Santa Claus, reindeer and sleigh wherein the Santa Claus and reindeer figures are collapsible and fit into a rectangular carrying box formed by collapsing the sleigh.

### BRIEF DESCRIPTION OF THE DRAWINGS

FIG. 1 is a front view of the standing Santa Claus figure in its erected state.

FIG. 1A is a front view of the sitting Santa Claus figure in its erected state.

FIG. 1B is a rear view of the sitting Santa Claus figure in its erected state.

FIG. 1C is a front view of the sitting Santa Claus with the front arm rotated upward for clearance.

FIG. 1D is a rear view of the sitting Santa Claus with the back arm rotated upward for clearance.

FIG. 1E is a side view of the sitting Santa Claus with the front and back arms positioned for folding clearance.

FIG. 1F is a side view of the sitting Santa Claus in its collapsed state with the top section folded downwardly onto the bottom section.

FIG. 2 is a side view of the Santa Claus figure in its erected state.

FIG. 3 is a rear view of the Santa Claus figure in its erected state.

FIG. 4 is a rear view of the Santa Claus figure with arms rotated and support leg collapsed to allow folding.

FIG. 5 is a side view of the Santa Claus figure with arms rotated and support leg collapsed to allow folding.

FIG. 6 is a side view of the Santa Claus figure during the operation of folding over onto itself.

FIG. 7 is a front view of the reindeer figure in its erected state.

FIG. 8 is a side view of the reindeer figure in its erected state.

FIG. 9 is a front view of the reindeer figure with stabilizing hips slid inward and antlers rotated downwardly.

FIG. 10 is a front view of the reindeer figure with the head and neck rotated towards the body.

FIG. 11 is a front view of the reindeer figure in its completely collapsed state with legs folded upwardly.

FIG. 12 is a side view of the reindeer figure in its completely collapsed state.

FIG. 13 is a perspective view of the sleigh figure in its erected state.

FIG. 14 is a side view of the sleigh figure in its erected state.

FIG. 15 is a top view of the sleigh figure in its erected state.

FIG. 16 is a side view of the sleigh figure with front and back wall upper panels folded downwardly and forward and rearward sidewall extensions folded inwardly.

FIG. 17 is a top view of the sleigh figure with front and back wall upper panels folded downwardly and forward and rearward sidewall extensions folded inwardly.

FIG. 18 is a front view of the sleigh figure depicting the downward folding of the collapsible upper sidewall sections.

FIG. 19 is a side view of the sleigh figure partially collapsed with upper sidewalls folded downwardly into the cavity and pieces of the sleigh runners slid inwardly and rotated.

FIG. 20 is a top view of the sleigh figure depicting the downward folded upper sidewalls.

FIG. 21 is a front view of the sleigh figure depicting the upward folding of the collapsed sleigh rails to fit under the box formed thereby.

FIG. 22 is a side view of the sleigh figure in its fully collapsed state, with front and rear lids rotated to close up the figure into an essentially rectangular box.

FIG. 23 is a front view of the multiple figure display of the standing Santa Claus, sleigh and reindeer in their fully erected states.

FIG. 24 is a perspective view of a decorative cart in its fully erected state.

FIG. 25 is a front view of a decorative cart in its fully erected state.

FIG. 26 is a side view of a decorative cart in its fully erected state.

FIG. 27 is a side view of a decorative cart with its upper front panel and upper back panel folded down and its upper sidewall forward and rearward extensions folded inward.

FIG. 27a is a top view of a decorative cart with its upper front panel and upper back panel folded down and its upper sidewall forward and rearward extensions folded inward.

FIG. 28 is a side view of a decorative cart with its collapsible upper sidewall sections folded down.

FIG. 28a is a top view of a decorative cart with its collapsible upper sidewall sections folded down.

FIG. 29 is a front view of a decorative cart depicting the interconnection details of the false wheels and support leg.

FIG. 30 is a side view of a decorative cart depicting the upward folding of the wheel support cross member and of the support leg.

FIG. 31 is a front view depicting the overlapping upward folding of the laterally disposed false wheels.

FIG. 31a is a side view of the decorative cart in its fully collapsed state, with front and rear lids rotated to close up the cart into an essentially rectangular box.

FIG. 32 is a front view of a snowman figure fully erected.

FIG. 32a is a side view of a snowman figure fully erected.

FIG. 33 is a rear view of a snowman figure fully erected.

FIG. 34 is a rear view of a snowman figure with upper arm and lower arm rotated to remove supports to allow collapsing of the figure.

FIG. 35 is a side view of a snowman figure with upper arm and lower arm rotated to remove supports to allow collapsing of the figure.

FIG. 36 is a side view of an snowman figure with the upper section folded down.

FIG. 37 is a side view of a snowman figure with the upper and middle sections folded down.

FIG. 38 is a side view of a snowman figure fully collapsed into a carrying box.

FIG. 39 is a perspective view of the snowman figure fully collapsed and contained within a carrying box.

### DETAILED DESCRIPTION OF THE INVENTION

In a preferred embodiment of the present invention, a multiple figure Christmas display having a standing Santa Claus FIG. 10, a reindeer FIG. 110 and a sleigh FIG. 210, is provided (see FIG. 23). Each of the three figures includes provisions for collapsing and folding into a more compact form which cooperates with the other figures to provide a highly portable and efficiently stored arrangement when not in use.

The first figure in the display, the standing Santa Claus FIG. 10, is comprised fundamentally of a head section 12, a body section 14 and a leg section 16. In its erect state the head section 12, body section 14 and leg section 16 are essentially co-planar (FIG. 2) and are maintained in the erect state by locking means discussed in more detail below. A raised arm 18 is attached to the rear side of the head section 12 at pivot 20 (FIG. 3). A lower arm 22 is attached to the rear of the body section 14 at pivot 24. In the erected state of the Santa Claus FIG. 10, the raised arm 18 is positioned to give the appearance of Santa Claus waving, while the lower arm 22 is positioned to give the appearance of being behind the back of the body section 14 of the standing Santa Claus FIG. 10.

A support leg 26 is attached to the leg section 16 by a full length support hinge 28, which is directly connected to a leg section hinge mounting block 30. In its erect state the standing Santa Claus FIG. 10 is free standing in a substantially vertical orientation and is supported by the support leg 26. The support leg 26 is prevented from moving beyond angular separation between the leg section 16 and support leg 26 by a chain linkage 32 connected therebetween. Other means of limiting the movement of the support leg 26 such as restricting hinges, elastic straps and the like, are specifically contemplated and do not depart from the principles of the present invention.

The standing Santa Claus FIG. 10 of the present invention is particularly advantageous because it has means for locking it into its erect state that can be adjusted without disassembly to allow it to be collapsed into a more compact form.

The first adjustment to collapse the standing Santa Claus FIG. 10 into a more compact form is to rotate the support leg 26 into face to face engagement with the leg section 16 (see FIG. 5). The support leg 26 is connected to the leg section 16 through the full length support hinge 28 and leg section hinge mounting block 30. A hole 34 is formed in the support leg 26 so that, in its collapsed state of face to face engagement with the leg section 16, the chain linkage 32 is not crushed between them.

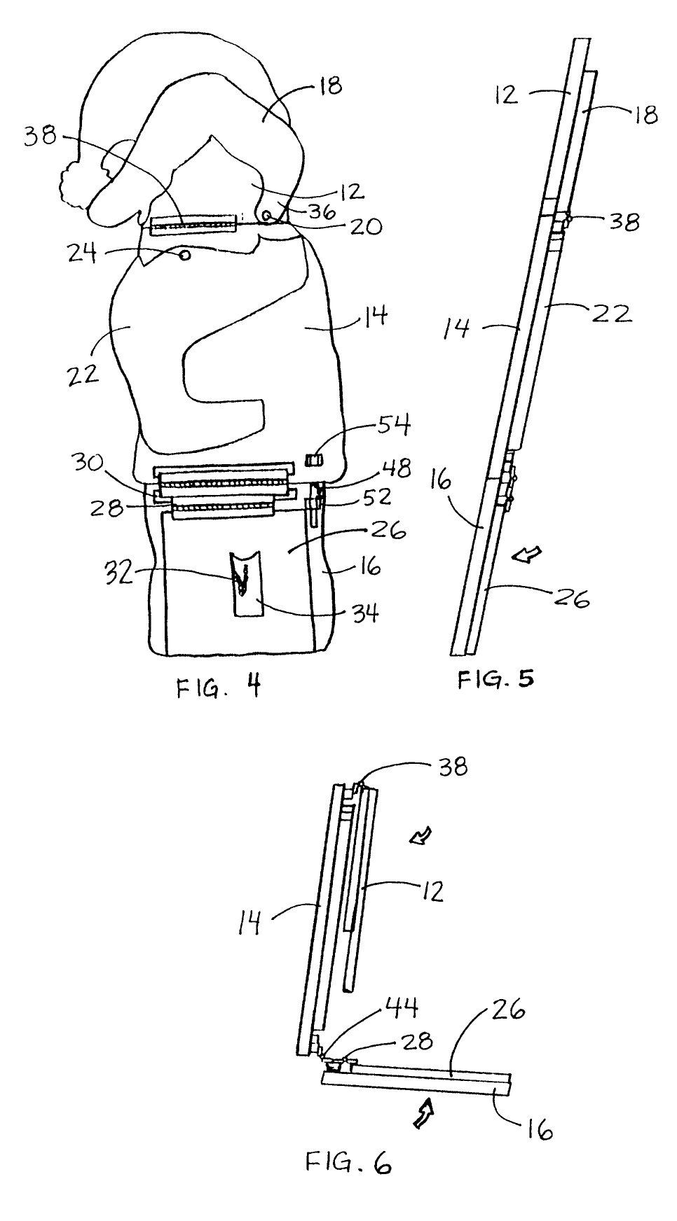

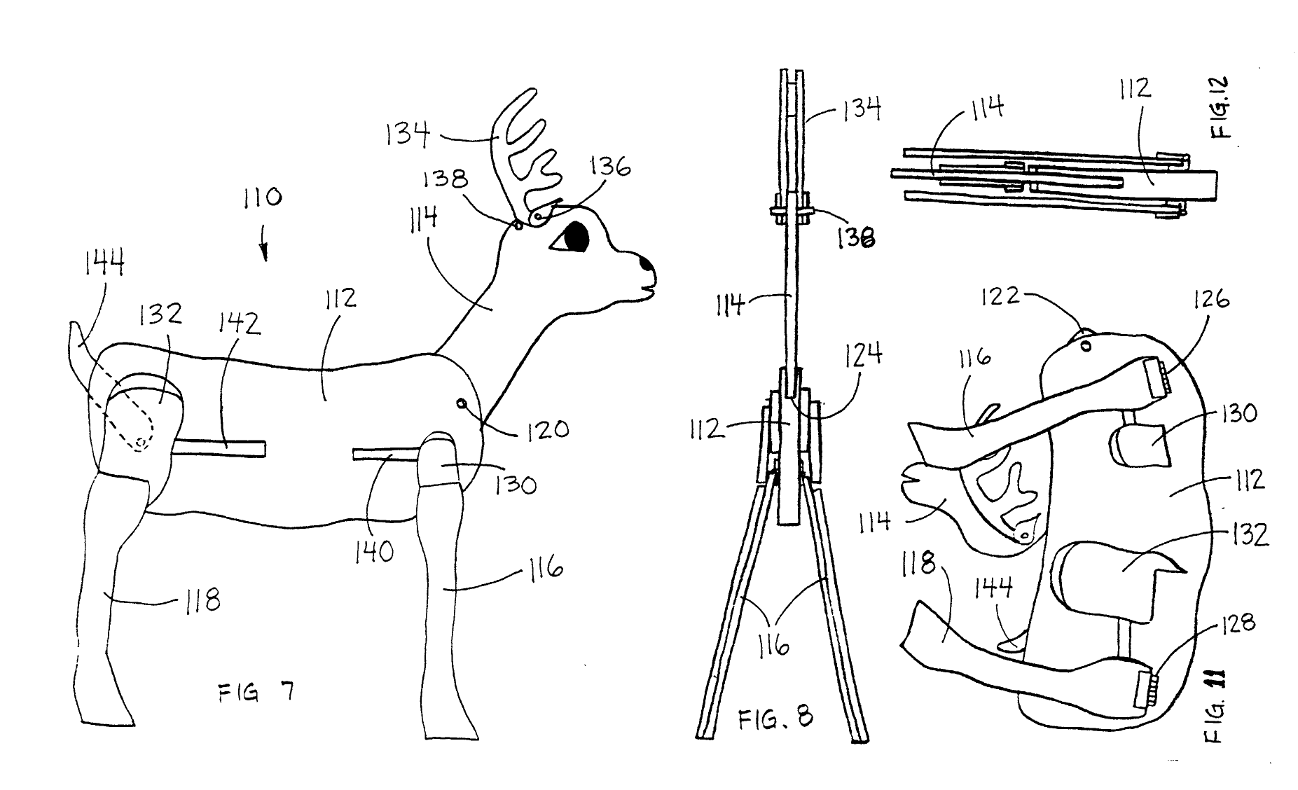

The next adjustment to collapse the standing Santa Claus FIG. 10 into a more compact form is to rotate the raised arm 18 about pivot 20, and to rotate the lower arm 22 about pivot 24, into positions that do not prevent folding of the head section 12 onto the body section 14 (see FIG. 4). In the erect state, the head section 12 is supported in an open, co-planar relationship with the body section 14 as a result of support provided by the uppermost extension 36 of the raised arm 18, which bridges the head section 12 and body section 14 and prevents folding along the upper hinge 38. When the raised arm 18 is rotated to remove the bridge support (FIG. 4) the head section 12 is free to rotate about upper hinge 38, allowing the head section 12 to be folded downwardly as shown in FIG. 6. To aid the folding of the head section 12 onto the body section 14, the upper hinge 38 therebetween is mounted on one side on a head pad 40 and on the other side on an upper body pad 42 to provide an offset. To make the collapsed standing Santa Claus FIG. 10 even smaller, the lower arm 22 is rotated about pivot 24 as shown in FIG. 4 to tuck it in behind and create more overlap with the body section 14.

Similar to the hinged connection with the head section 12, the body section 14 interconnected to the leg section 16 at lower hinge 44 includes an offset through a lower body pad 46 and the leg section hinge mounting block 30. The standing Santa Claus FIG. 10 can then be collapsed from its erect state without disassembly by adjusting the position of the slide lock 48 between the body section 14 and leg section 16. A latch 50 bridging the body section 14 and leg section 16 is held in place by a leg sleeve 52 and body sleeve 54. To allow the leg section 16 to be folded onto the body section 16, the latch 50 is slid downwardly, out of the body sleeve 54, so that the leg section 16 is free to rotate, and to be folded, about the lower hinge 44. The lower body pad 46 and hinge mounting block 30 are sized such that they provide proper offsets to allow the leg section 16 to be fully folded over onto the head section 12 as shown in FIG. 6.

In its collapsed state, the standing Santa Claus FIG. 10 is essentially folded over onto itself in three (3) sections, resulting in a compact form of roughly one-third the size. It is appropriately sized so that the collapsed Santa Claus FIG. 10 fits within the collapsed sleigh FIG. 210, discussed in more detail below.

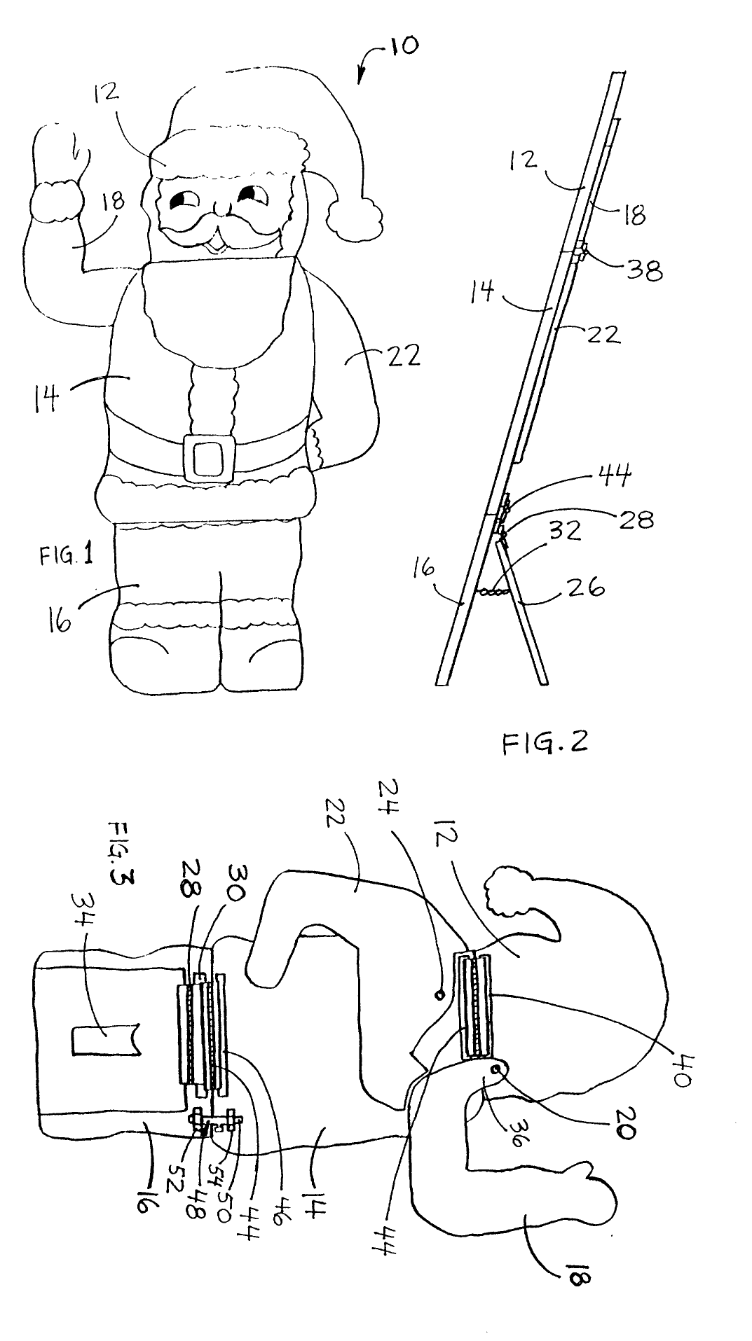

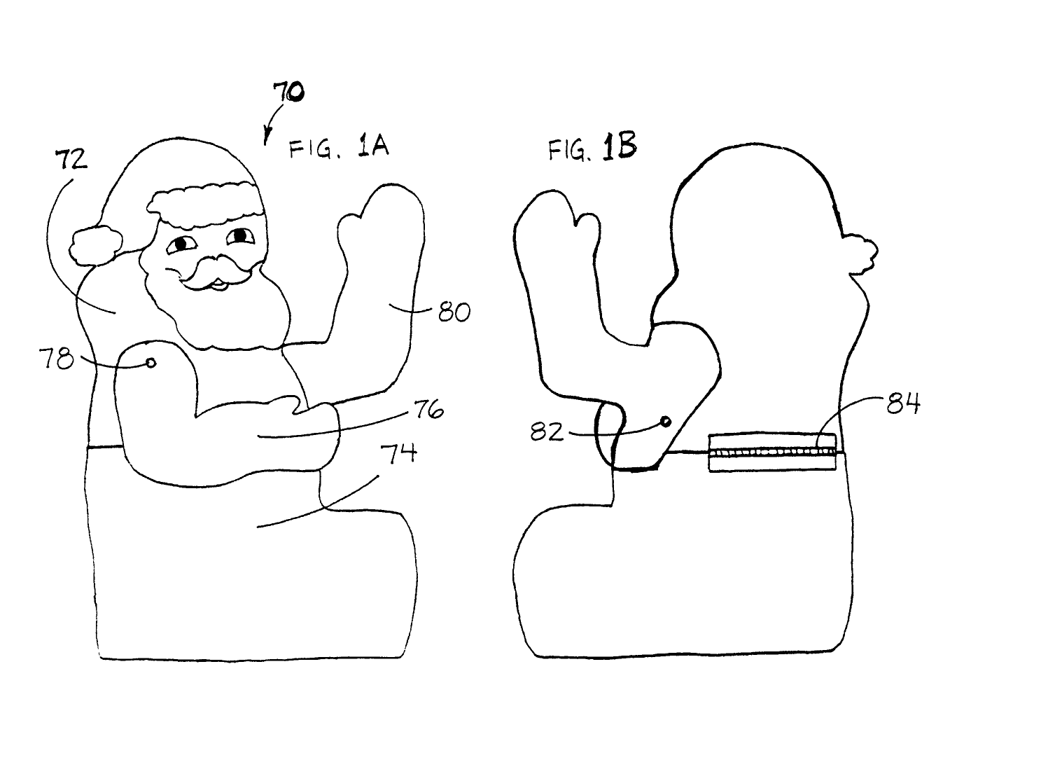

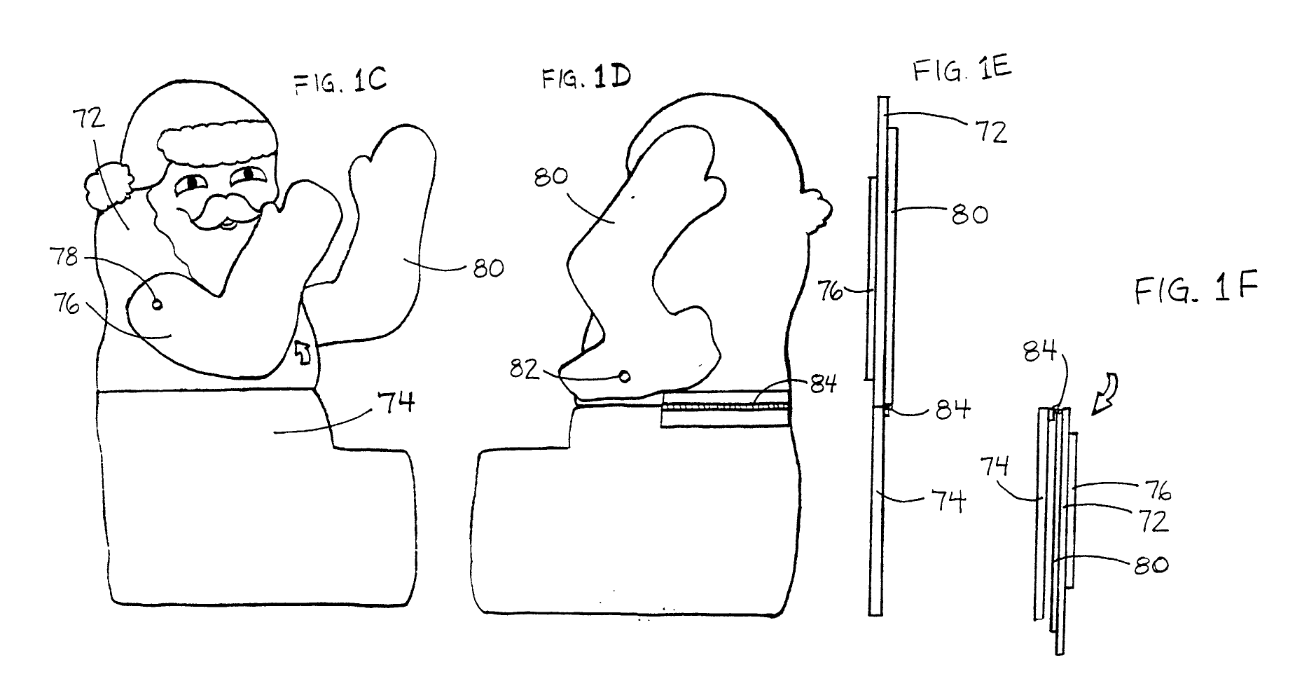

Another embodiment of the present invention provides a sitting Santa Claus FIG. 70 (FIG. 1A) which comprises an upper section 72 and a lower section 74. In its erected state, the sitting Santa Claus 70 has a front arm 76, connected at pivot 78 to the front of the upper section 72, and a back arm 80 connected at pivot 82 to the rear of the upper section 72, extended as shown in FIG. 1A. Means for connecting the upper section 72 to the lower section 74 is provided at hinge 84 as shown in FIG. 1B. Means for locking the sitting Santa Claus FIG. 70 in its erect state are provided by positioning the front arm 76 and back arm 80 as shown in FIGS. 1A and 1B to bridge the connection between the upper section 72 and lower section 74. As a result the sitting Santa Claus 70 remains in its erect state with the upper section 72 and lower section 74 being essentially co-planar.

Means for collapsing the sitting Santa Claus FIG. 70 are provided by first rotating the front arm 76 upwardly as shown in FIG. 1C to allow clearance for the upper section 72 to be folded downwardly onto the lower section 74. In addition, the back arm 80 is rotated upwardly as shown in FIG. 1D to similarly provide clearance for folding. With both the front arm 76 and back arm 80 rotated upwardly, as shown in side view in FIG. 1E, the upper section 72 can be folded downwardly onto the lower section 74 as indicated at FIG. 1F.

In its collapsed state the sitting Santa Claus FIG. 70 is essentially folded over onto itself in two sections, resulting in a compact form of roughly one-half the size. It is appropriately sized so that the collapsed sitting Santa Claus FIG. 70 fits fully within the collapsed sleigh FIG. 210. In its erect state the sitting Santa Claus 70 sits upright in the erect sleigh FIG. 210.

The reindeer FIG. 110 of the preferred embodiment is depicted in its erected state in FIGS. 7 and 8. It fundamentally comprises a body section 112, a head and neck section 114, a pair of front legs 116 and a pair of back legs 118. Similar to the Santa Claus FIG. 10, the reindeer FIG. 110 includes means for locking it into its erect state that can be adjusted without disassembly to allow it to be collapsed into a more compact form.

In its erect state, the head and neck section 114, connected to the body section 112 at pivot 120, is maintained in the upward position shown in FIG. 7 by a lower extension 122 of the head and neck section 114 which rests against stop member 124, so that the head and neck section 114 is maintained in that relationship to the body section 112. The front legs 116 are connected to the body section 112 by a pair of front leg hinges 126, while the back legs 118 are connected by a pair of back leg hinges 128. The downward depending relationship between the body section 112 and the front legs 116 and rear legs 118 is maintained by preventing the front legs 116 and rear legs 118 from rotating about the hinges 126, 128. This is accomplished using front thigh pads 130 and back thigh pads 132 that overlap the hinges 126, 128 and the tops of the legs 116, 118 as shown in FIGS. 7 and 8.

Antlers 134 are connected to the head and neck section 114 at pivot 136 and, in the erect state of the reindeer FIG. 110, are held in place by a stop pin 138, as shown in FIG. 7.

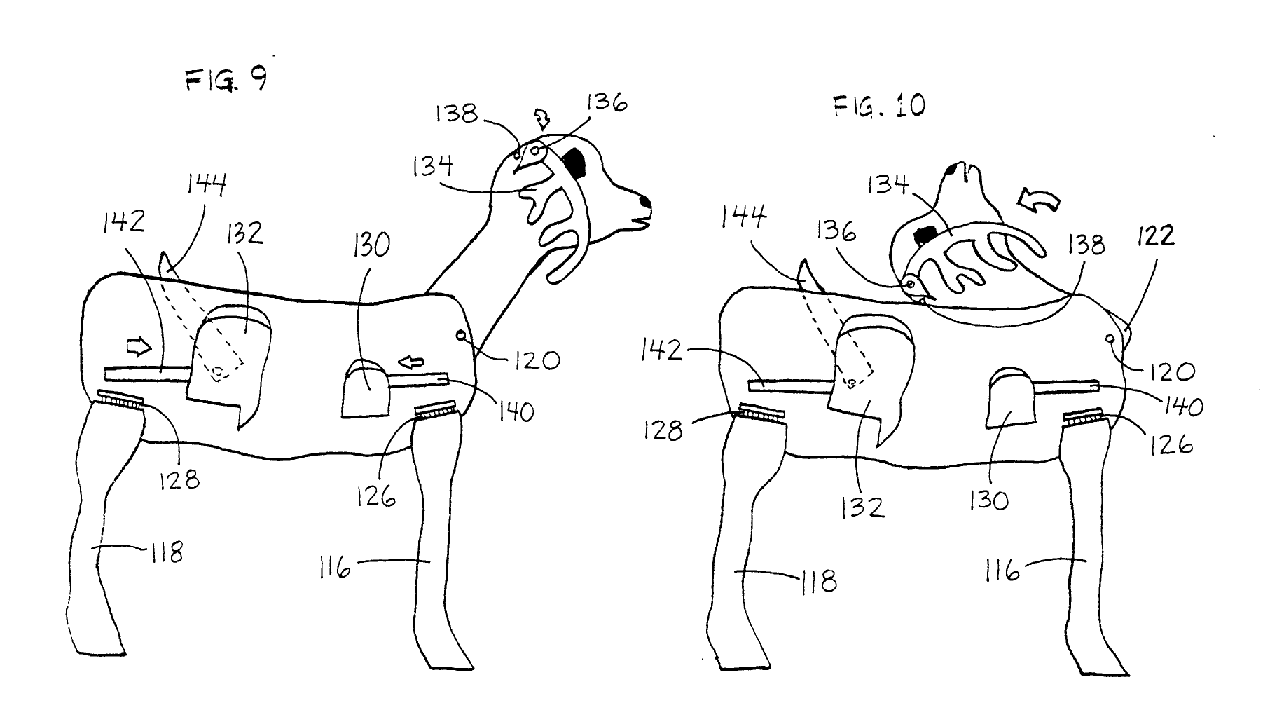

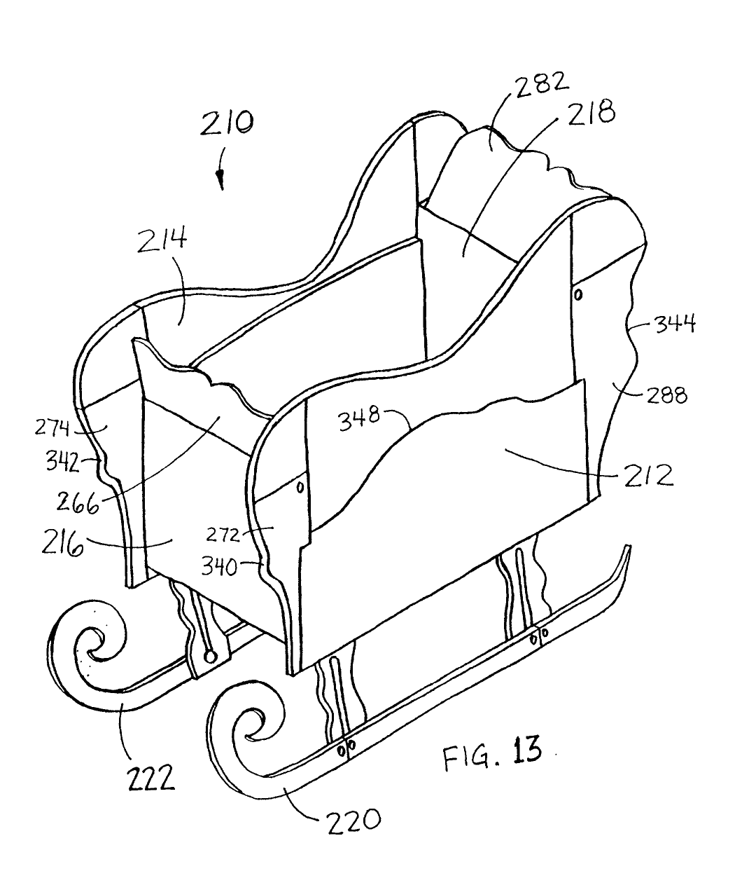

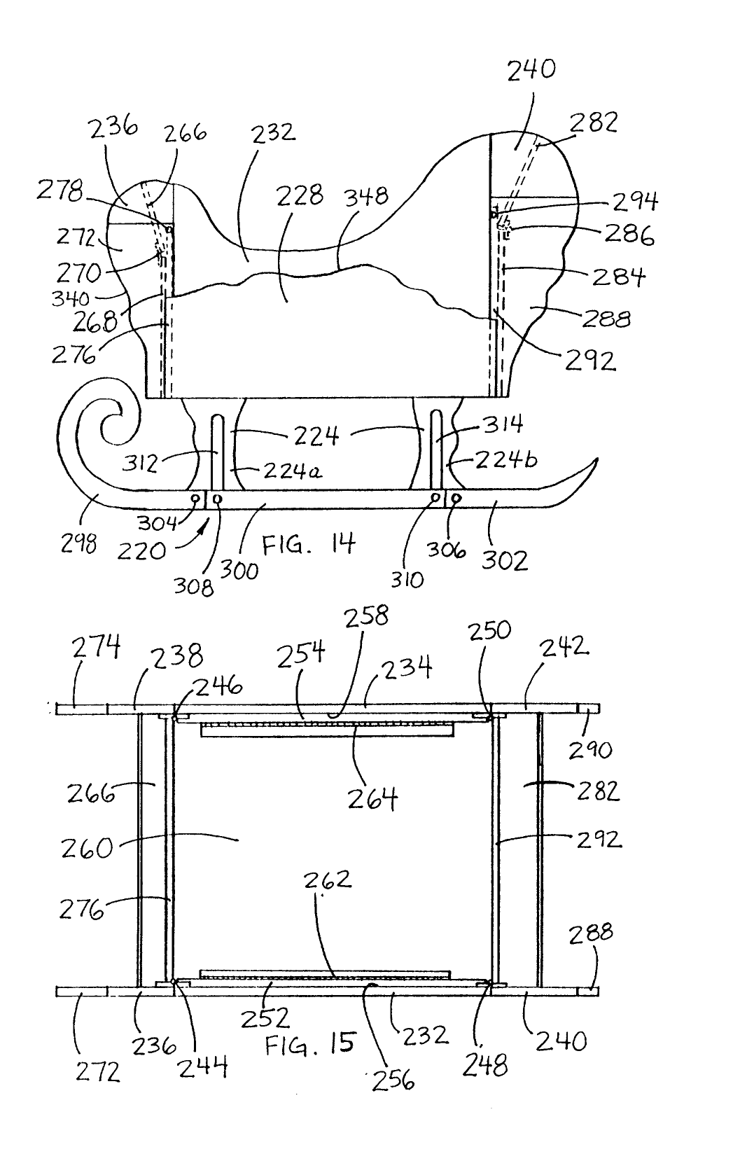

To collapse the reindeer FIG. 110 into a more compact form, the first element providing adjustment without disassembly is pivot 136 which allows the antlers 134 to be rotated in the direction shown in FIG. 9. The next elements that are adjusted are the front thigh pads 130 and back thigh pads 132 which are slid inwardly to uncover the hinges 126, 128, as shown in FIG. 9. The front thigh pads 130, positioned on opposite sides of the body section 112 (FIG. 8), are connected by a cross member (not shown) which extends through the body section 112 and which is slidable in front slot 140. Back thigh pads 132 are similarly connected such that the cross member connecting them is slidable in back slot 142. The slidability of the front thigh pads 130 and back thigh pads 132 provide means for adjusting the reindeer FIG. 110 from the erect state (FIG. 7) to the collapsed state (FIG. 9).

A tail 144 is positioned within the body section 112 in a hollow portion 146 thereof. In the erected state of the reindeer FIG. 110, the tail 144 extends from the upper back end of the body section 112, as shown in FIG. 7. When the reindeer FIG. 110 is collapsed, the tail 144, connected to the back thigh pads 132 at the connecting cross member, slides inwardly with the rear thighs 132 as shown in FIG. 9.

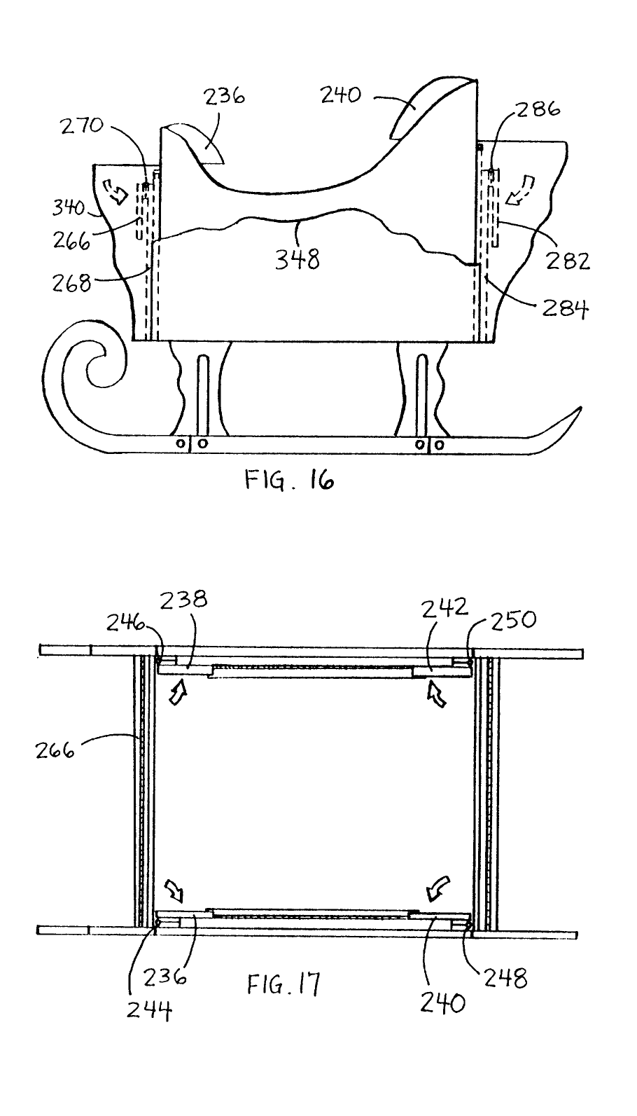

After rotating the antlers 134, sliding the front thigh pads 130 inward, and sliding the rear thigh pads 132 and tail 144 inward, the next element that is adjusted to collapse the reindeer FIG. 110 is provided by pivot 120 about which the head and neck section 114 is rotated rearwardly, as shown in FIG. 10, until the antlers stop pin 138 contacts the upper edge of the body section 112 (FIG. 10). The final adjustment means allowing collapse of the reindeer FIG. 110 is provided by hinges 126, 128 which allow upward folding of the front legs 116 and back legs 118 as depicted in FIGS. 11 and 12. The final collapsed form of the reindeer FIG. 110, shown in FIG. 11, is sized to fit within the collapsed form of the sleigh FIG. 210, discussed in more detail below.

The sleigh FIG. 210, shown in FIG. 13 in its fully erected state, fundamentally comprises interconnected sidewalls 212, 214, a front wall 216, a rear wall 218, and two runners 220, 222, vertically depending from to an underside 226 of the sleigh FIG. 210. Means for adjusting the interconnections between these elements are provided such that the sleigh FIG. 210 can be collapsed into a smaller, more portable and easily stored form without requiring any disassembly.

The laterally disposed vertical sidewalls 212, 214 include fixed lower sections 228, 230. They also include collapsible upper sections 232, 234 with forward extensions 236, 238 and rearward extensions 240, 242. The forward extensions 236, 238 are interconnected to collapsible upper sections 232, 234 by hinges 244, 246. Rearward extensions 240, 242 are interconnected to the collapsible upper sections 232, 234 by hinges 248, 250.

Interior sidewall panels 252, 254 are affixed to the interior sides 256, 258 of the collapsible upper sections 232, 234 and extend down to the floor panel 260. The interior sidewall panels are attached to the floor panel 260 by full length hinges 262, 264.

The front wall 216 comprises an upper panel 266 which extends and is held between the forward sidewall extensions 236, 238 in the erect state, as shown in FIG. 13. The upper panel 266 is interconnected to a lower front wall panel 268 by hinge 270. The lower front wall panel 268 is positioned between and securely affixed to laterally disposed front sidewalls 272, 274. The front sidewalls 272, 274 are also interconnected to an interior front wall 276 at pivots 278, 280.

The rear wall 218 comprises an upper back panel 282 which extends and is held between the rearward sidewall extensions 240, 242 in the erect state as shown in FIG. 13. The upper back panel 282 is interconnected to a lower back panel 284 by hinge 286. The lower back panel 284 is positioned between and securely affixed to laterally disposed rear sidewalls 288, 290. The rear sidewalls 288, 290 are also interconnected to an interior back wall 292 at pivots 294, 296.

The runners 220, 222 are attached to the underside 226 of the floor panel 260 of the sleigh FIG. 210 by four downward depending legs 224. Each runner 220, 222 is so attached by a front leg 224a and a back leg 224b. Each runner 220, 222 itself comprises a leading piece 298, a middle piece 300, and a trailing piece 302. The leading piece 298 is attached to the front leg 224a at pivot 304, and the trailing piece 302 is attached to the rear leg 224b at pivot 306. The middle piece 300 is attached to both legs 224a, 224b by pins 308, 310 which extend through and are slidably positioned in slots 312, 314 formed in legs 224.

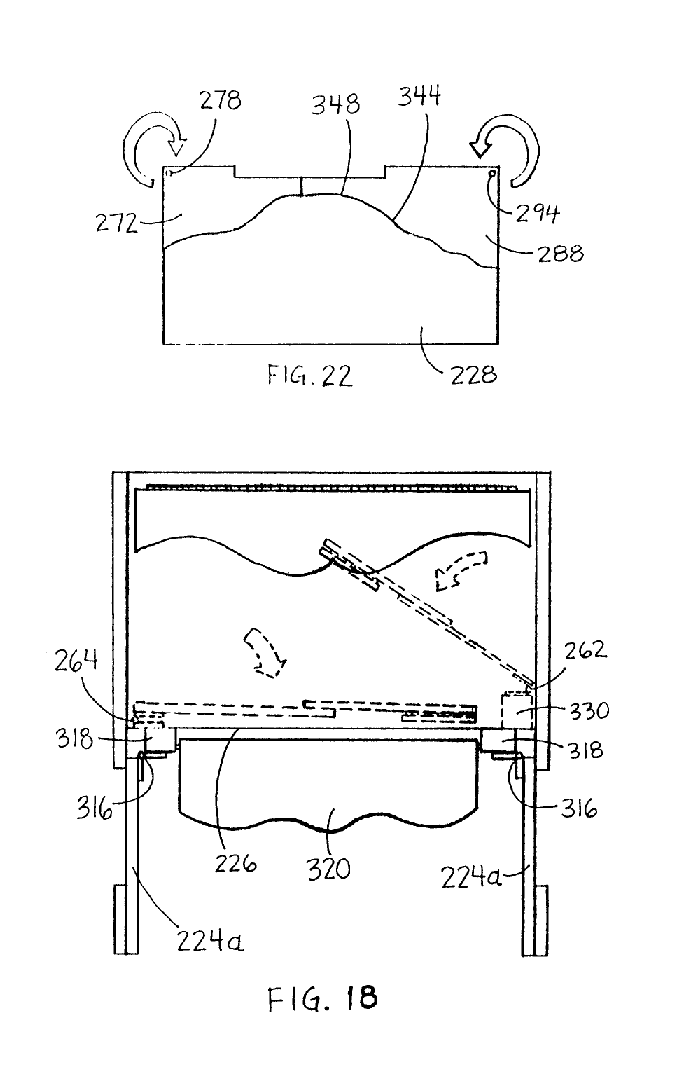

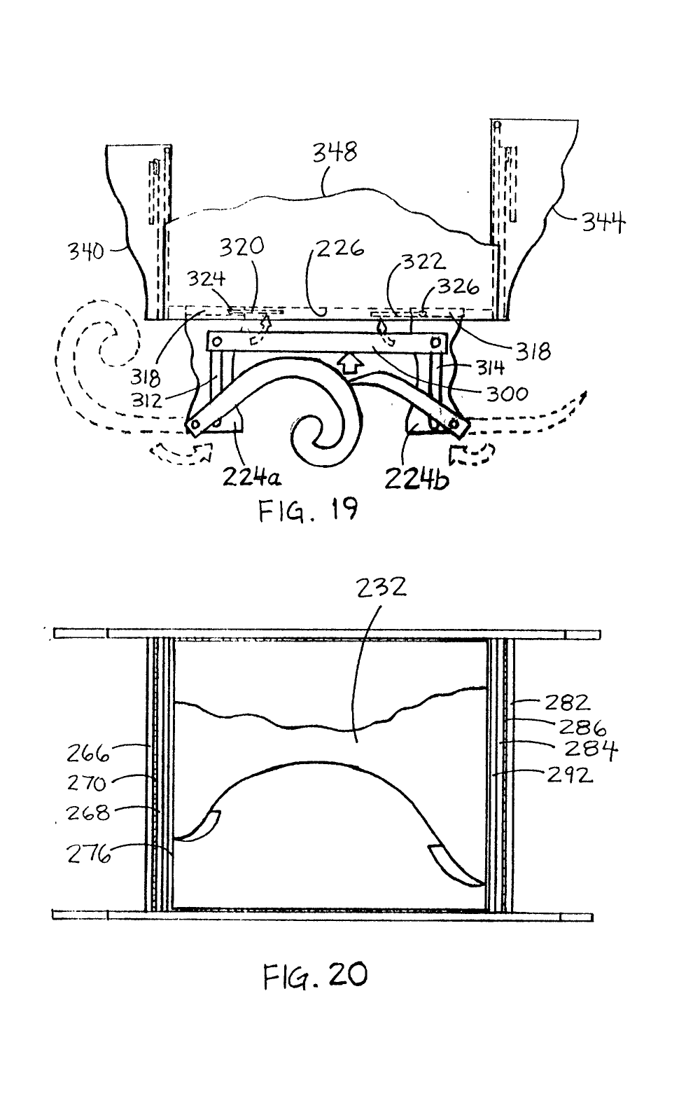

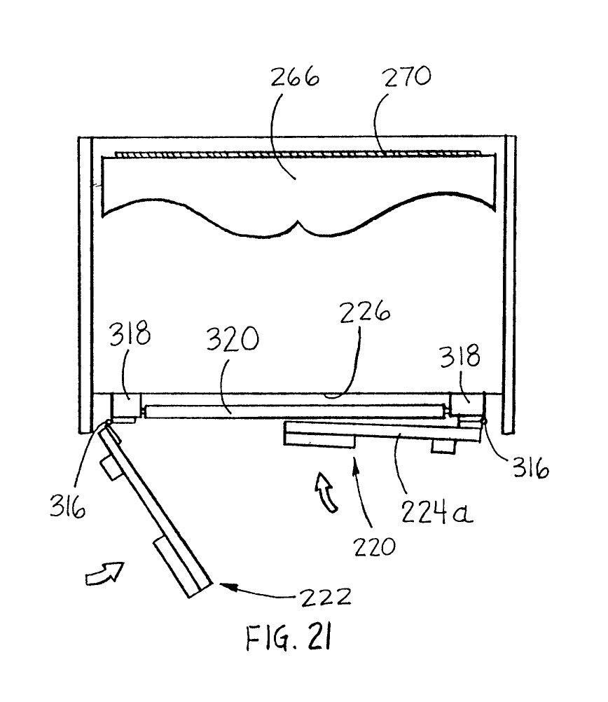

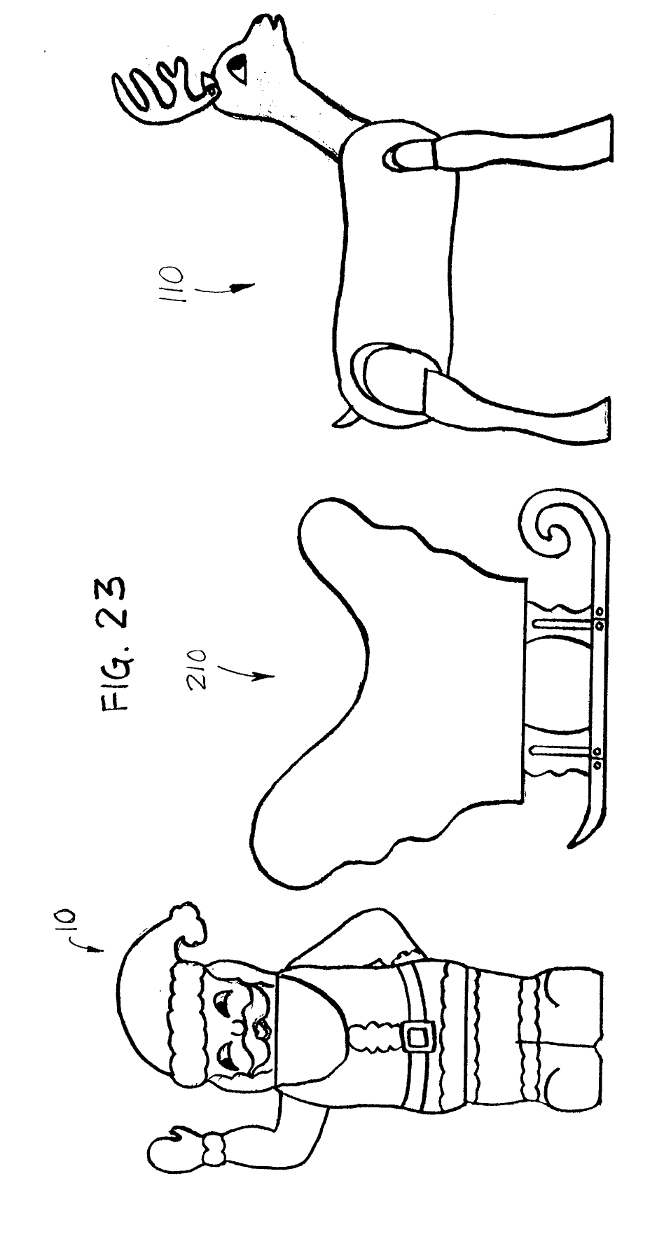

The legs 224 are interconnected by hinges 316 to mounting blocks 318 which are securely affixed to the underside 226 of the floor panel 260 (FIG. 18). In the erect state of the sleigh 210, the legs 224 depend perpendicularly downward from the floor panel 260, and are maintained in that position by a front cross member 320 which is positioned laterally between the pair of front legs 224a, and a back cross member 322 which is positioned laterally between the pair of back legs 224b. The front cross member 320 is permanently pivotally interconnected to the forward mounting blocks 318 at pivots 324, and the back cross member 322 is permanently pivotally interconnected to the rear mounting blocks 318 at pivots 326.

The sleigh FIG. 210 includes means for collapsing it, discussed below, into a smaller, more transportable and easily stored form. In the collapsed form the sleigh FIG. 210 provides an enclosure for other collapsed figures such as the Santa Claus FIG. 10 and reindeer 110, without requiring disassembly.

To collapse the sleigh FIG. 210, first the upper front wall panel 266 is folded down at hinge 270 onto the lower front wall panel 268, and the upper back panel 282 is folded down at hinge 286 onto the lower back panel 284, as indicated by the arrows in FIG. 16. Next, the forward sidewall extensions 236, 238 are folded inwardly at hinges 244, 246 and rear sidewall extensions 240, 242 are folded inwardly at hinges 248, 250, as indicated by the arrows in FIG. 17.

Additional means for collapsing are provided that allow the upper sidewall sections 232, 234 to be folded downward. Full length hinges 262, 264 which are anchored to the floor panel 260 allow the interior sidewall panels 252, 254 (to which the interior sides 256, 258 of the collapsible upper sidewall sections 232, 234 are rigidly affixed) to be folded down as shown in FIG. 18. An offset block 330 is provided between the hinge 262 and floor panel 260 so that the folding down of the latter interior sidewall panel 252 is not obstructed by the previously folded interior sidewall panel 254 (FIG. 18).

Additional means for collapsing the sleigh FIG. 210 are provided for the runners 220, 222. First, the front cross member 320 is rotated upwardly at pivot 324 while the back cross member 322 is rotated upwardly at pivot 326 until they contact the underside 226 of the floor panel 260, as shown in FIG. 19. Next, the sliding connection between the runner middle piece 300 and slots 312, 314 allows upward sliding of the middle piece 300 as shown in FIG. 19. Finally, the runner leading piece 298 is rotated at pivot 304 while the trailing piece 302 is rotated at pivot 306, as shown in FIG. 19. These elements allow the runners 220, 222 to be folded up under and adjacent to the floor panel 260 at hinges 316, as shown in FIG. 21.

The result of the foregoing collapse is that the sleigh FIG. 210 is transformed to a generally rectangularly shaped box having a rectangular storage cavity 332 defined between the fixed lower sidewall sections 228, 230 and between interior front wall 276 and interior back wall 292. The collapsed Santa Claus FIG. 10 and collapsed reindeer FIG. 110 fit within the cavity 332 such that the final collapse of the sleigh FIG. 210, done by rotating the front sidewalls 272, 274 about pivots 278, 280 and rotating the rear sidewalls 288, 290 about pivots 294, 296, are not obstructed. The front sidewalls 272, 274 have defined decorative edges 340, 342 and the rear sidewalls 288, 290 have similar decorative edges 344, 346 that correspond and mate with the curvature of the upper edges 348, 350 of the fixed lower sidewall sections 228, 230. The result is that the rotation of the front sidewalls 272, 274 with affixed front wall panels 266, 268, and rotation of the rear sidewalls 288, 290, with affixed back panels 282, 284 comprise closing the lid of the box and result in a highly portable and conveniently stored box, shown in FIG. 21, containing several large Christmas display figures.

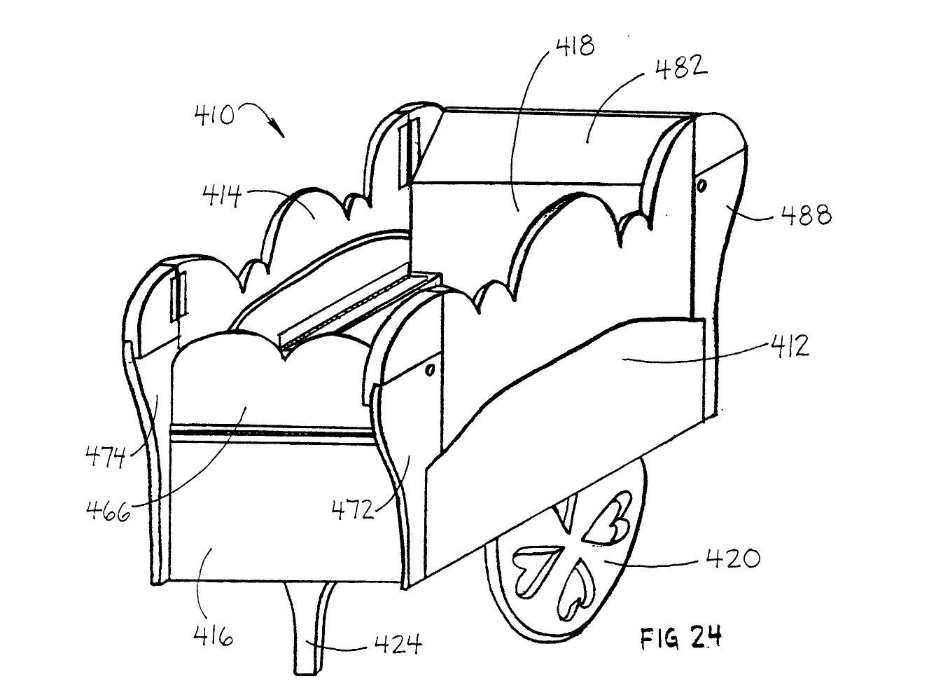

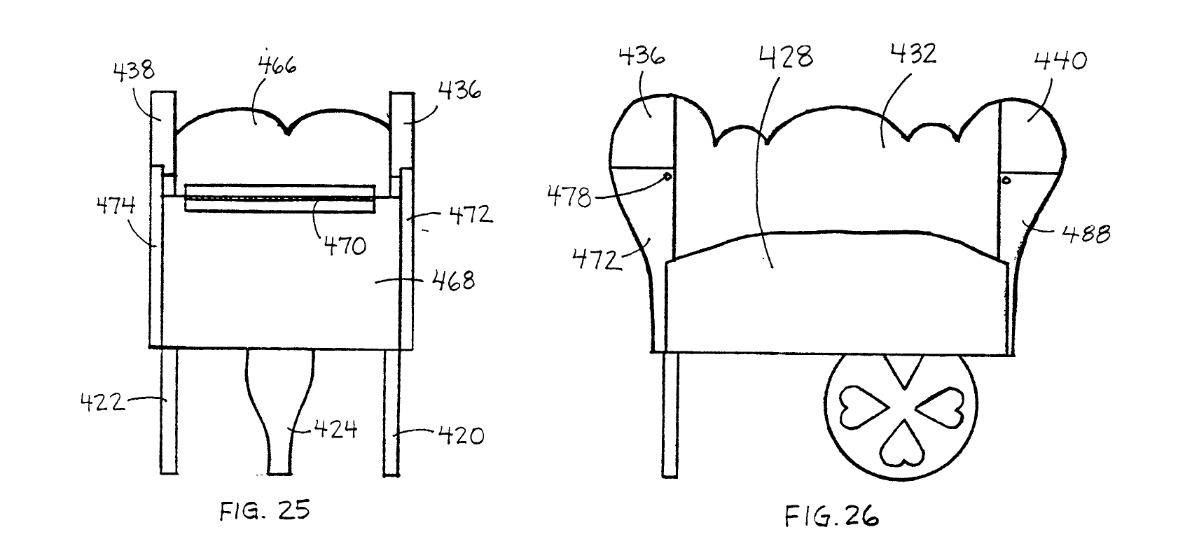

Another embodiment of the present invention comprises the non-holiday decorative figure of a miniature cart 410 shown in FIG. 24 in its fully erect state. The cart 410 fundamentally comprises interconnected sidewalls 412, 414, a front wall 416, a rear wall 418, and two false wheels 420, 422, vertically depending from an underside 426 of the cart 410. Means for adjusting the interconnections between these elements are provided such that the cart 410 can be collapsed into a smaller, more portable and easily stored form without requiring any disassembly.

The laterally disposed vertical sidewalls 412, 414 include fixed lower sections 428, 430. They also include collapsible upper sections 432, 434 with forward extensions 436, 438 and rearward extensions 440, 442. The forward extensions 436, 438 are interconnected to collapsible upper sections 432, 434 by hinges 444, 446. Rearward extensions 440, 442 are interconnected to the collapsible upper sections 432, 434 by hinges 448, 450.

Interior sidewall panels 452, 454 are affixed to the interior sides 456, 458 of the collapsible upper sections 432, 434 and extend down to the floor panel 460. The interior sidewall panels 452, 454 are attached to the floor panel 460 by full length hinges 462, 464.

The front wall 416 comprises an upper panel 466 which extends and is held between the forward sidewall extensions 436, 438 in the erect state, as shown in FIG. 24. The upper panel 466 is interconnected to a lower front wall panel 468 by hinge 470. The lower front wall panel 468 is positioned between and securely affixed to laterally disposed front sidewalls 472, 474. The front sidewalls 472, 474 are also interconnected to an interior front wall 476 at pivots 478, 480.

The rear wall 418 comprises an upper back panel 482 which extends and is held between the rearward sidewall extensions 440, 442 in the erect state as shown in FIG. 24. The upper back panel 482 is interconnected to a lower back panel 484 by hinge 486. The lower back panel 484 is positioned between and securely affixed to laterally disposed rear sidewalls 488, 490. The rear sidewalls 488, 490 are also inter connected to an interior back wall 492 at pivots 494, 496.

The false wheels 420, 422 are attached to the underside 426 of the floor panel 460 of the cart 410 by two full length hinges 516, 517, hinge 517 of the latter folded false wheel 422 having an offset 519 interposed between the hinge 517 and the underside 426 of the floor panel 460.

In the erect state of the cart 410, the false wheels 420, 422 depend vertically downward from the floor panel 460, and are maintained in that position by a cross member 520 which is positioned laterally between the false wheels 420, 422. The cross member 520 is permanently interconnected to the underside 426 of the floor panel 460 at hinge 524.

A support leg 424 interconnected by hinge 500 to the underside 426 of the floor panel 460 near the front of the cart 410, holds up the cart 410 along with the false wheels 420, 422, in the erect state.

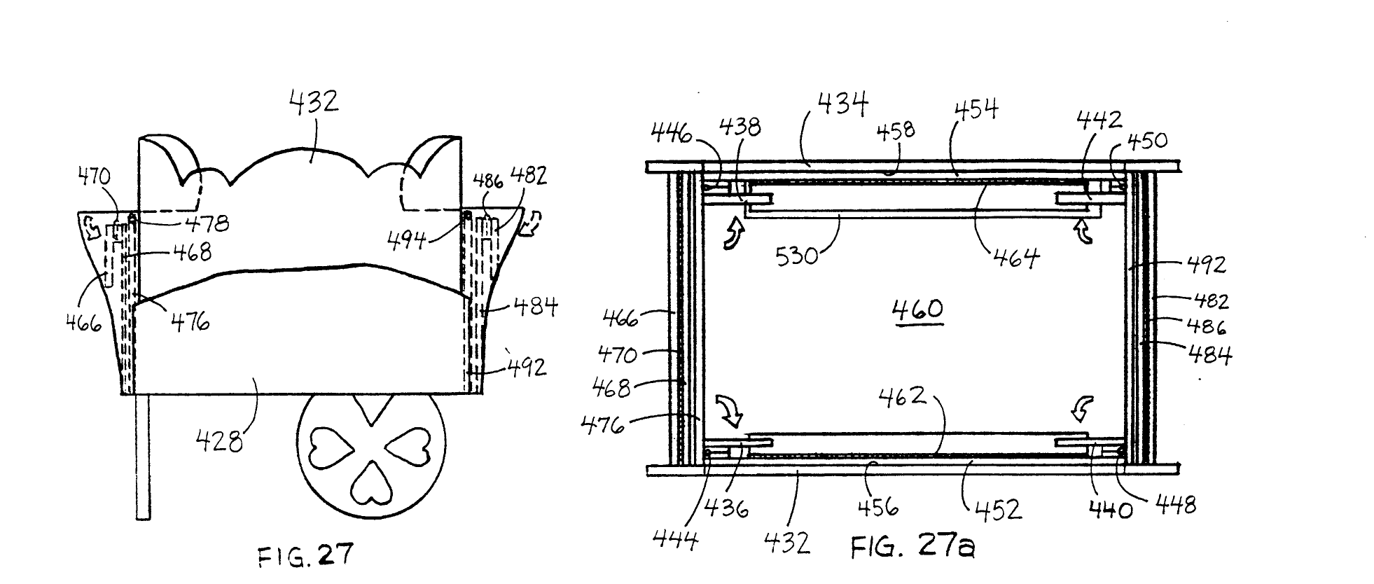

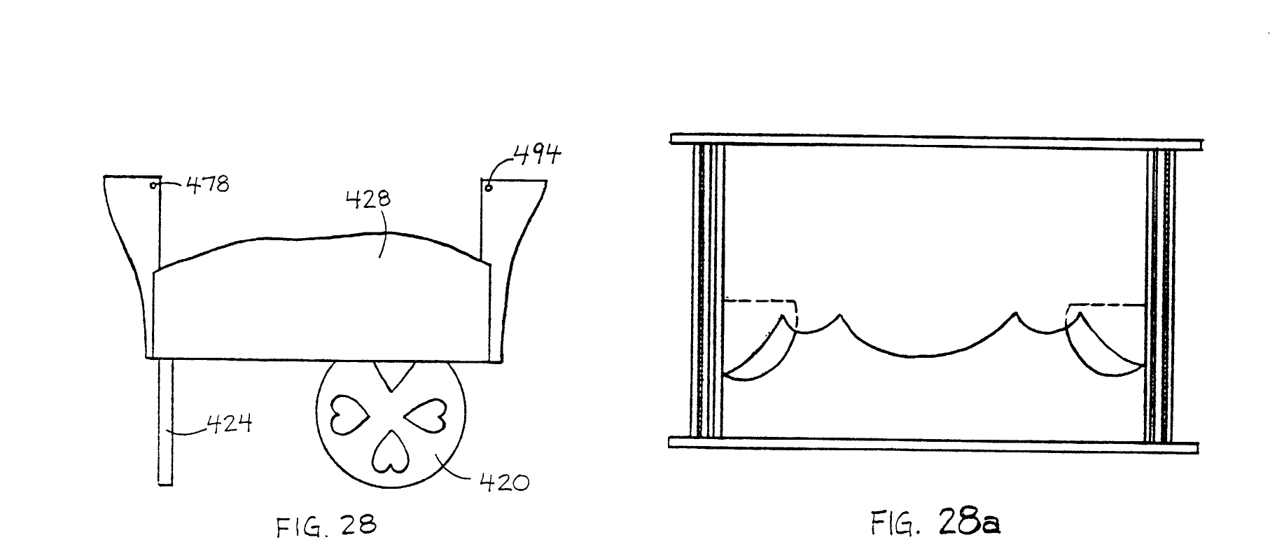

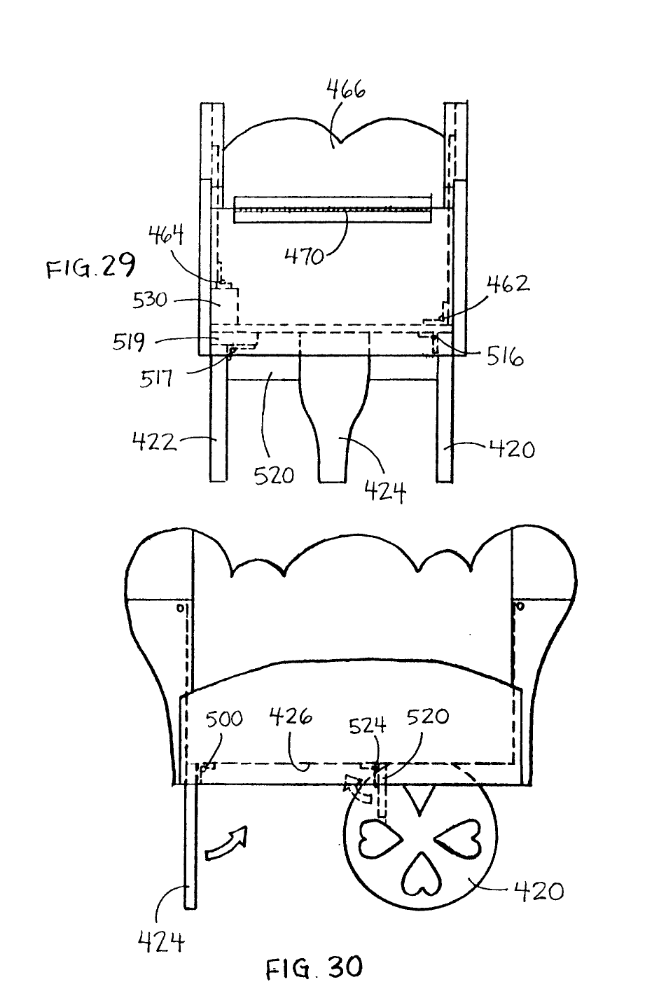

The cart 410 includes means for collapsing it, discussed below, into a smaller, more transportable and easily stored form without requiring disassembly. First, the upper front wall panel 466 is folded down at hinge 470 onto the lower front wall panel 468, and the upper back panel 482 is folded down at hinge 486 onto the lower back panel 484, as indicated by the arrows in FIG. 27. Next, the forward sidewall extensions 436, 438 are folded inwardly at hinges 444, 446 and the rear sidewall extensions 440, 442 are folded inwardly at hinges 448, 450, as indicated by the arrows in FIG. 27a.

Additional means for collapsing are provided that allow the upper sidewall sections 432, 434 to be folded downward. Full length hinges 462, 464 which are anchored to the floor panel 460 allow the interior sidewall panels 452, 454 (to which the interior sides 456, 458 of the collapsible upper sidewall sections 432, 434 are rigidly affixed) to be folded down. An offset block 530 between the hinge 462 and floor panel 460 is provided so that the folding down of the latter interior sidewall panel 452 is not obstructed by the previously folded interior sidewall panel 454.

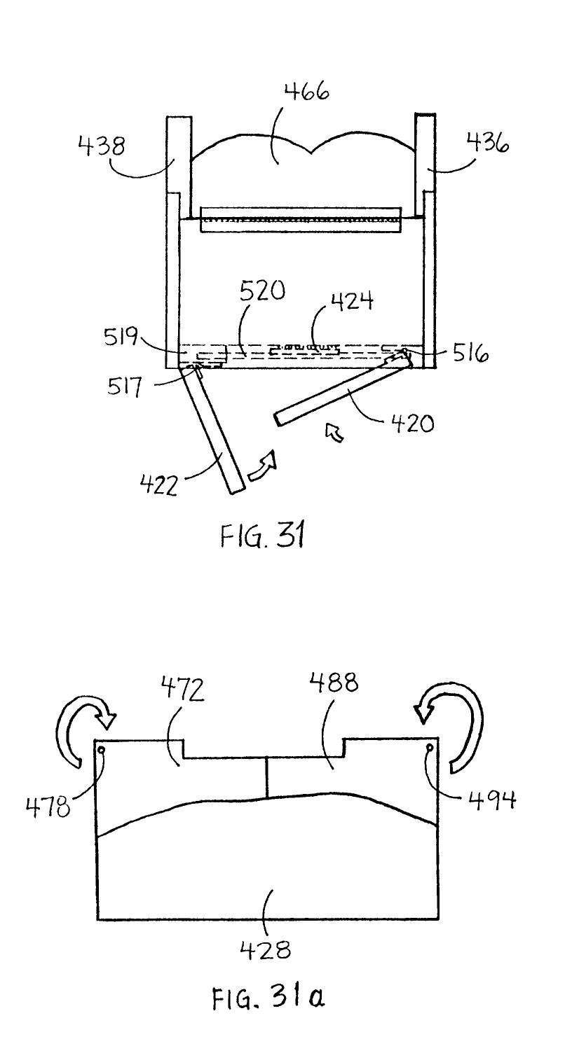

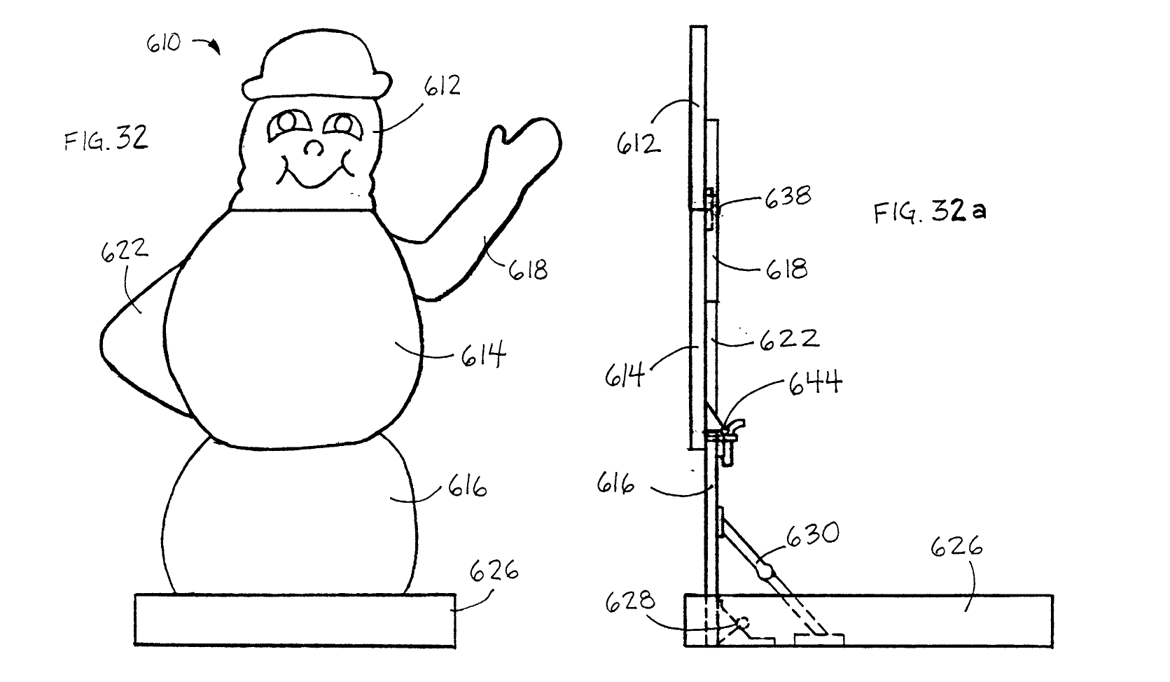

Additional means for collapsing the cart 410 are provided for the false wheels 420, 422. First, the cross member 520 is rotated upwardly at hinge 524 until it contacts the underside 426 of the floor panel 460, as shown in FIG. 30. Next, the support leg 424 is rotated upward at hinge 500 until it contacts the previously folded cross member 520. Finally, the false wheels 420, 422 are folded upwardly at hinges 516, 517 as shown in FIG. 31.

The result of the foregoing collapse is that the cart 410 is transformed to a generally rectangularly shaped box having a rectangular storage cavity 532 defined between the fixed lower sidewall sections 428, 430 and between interior front wall 476 and interior back wall 492. The final collapse of the cart 410, done by rotating the front sidewalls 472, 474 about pivots 478, 480 and rotating the rear sidewalls 488, 490 about pivots 494, 496, are not obstructed. The front sidewalls 472, 474 have defined decorative edges 440, 442 and the rear sidewalls 488, 490 have similar decorative edges 544, 546 that correspond and mate with the curvature of the upper edges 548, 550 of the fixed lower sidewall sections 428, 430. The result is that the rotation of the front sidewalls 472, 474 with affixed front wall panels 466, 468, and rotation of the rear sidewalls 488, 490, with affixed back panels 482, 484 comprise closing the lid of the box and result in a highly portable and conveniently stored box.

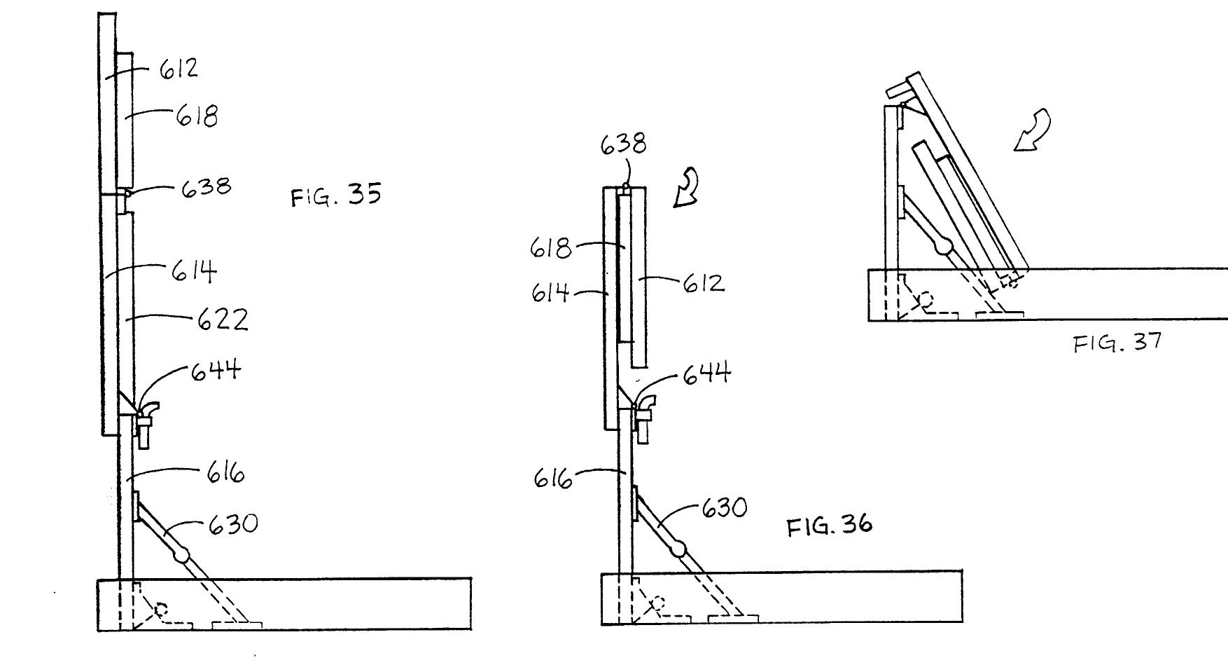

Another embodiment of the present invention, a snowman FIG. 610, is comprised fundamentally of a head section 612, a body section 614 and a leg section 616. In its erected state the head section 612, body section 614 and leg section 616 are maintained in an upright vertical configuration (FIG. 35) and are held in the erected state by locking means discussed in more detail below. A raised arm 618 is attached to the rear side of the head section 612 at pivot 620 (FIG. 33). A lower arm 622 is attached to the rear of the body section 614 at pivot 624. In the erected state of the snowman FIG. 610, the raised arm 618 is positioned to give the appearance of the snowman 610 waving, while the lower arm 622 is positioned to give the appearance of being behind the back of the body section 614 of the snowman FIG. 610.

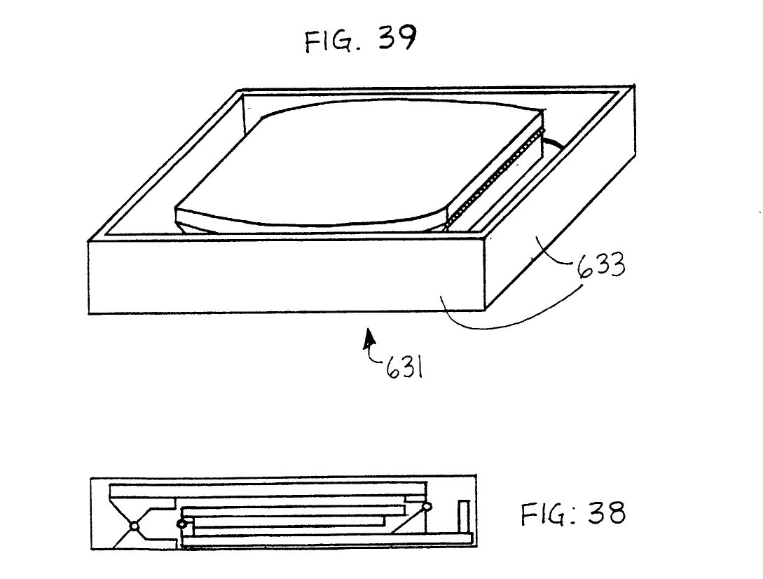

A base 626 is attached to the leg section 616 by a full length support hinge 628 and by a locking arm 630. In its erect state the snowman FIG. 610 is free standing in a substantially vertical orientation and is supported by the base 626 by locking the arm 630 into position, as shown in FIG. 35. The base 626 comprises an open box 631 having a bottom 632 and four upstanding walls 633 (FIG. 39).

The snowman FIG. 610 of the present invention is particularly advantageous because it has means for holding it erect that can be adjusted without disassembly to allow it to be collapsed into a more compact form into the box 631. The next element that is adjusted to collapse the snowman FIG. 610 into a more compact form is the locking arm 630 which is bent inwardly to allow the base 626 to be rotated toward the leg section 616 about hinge 628.

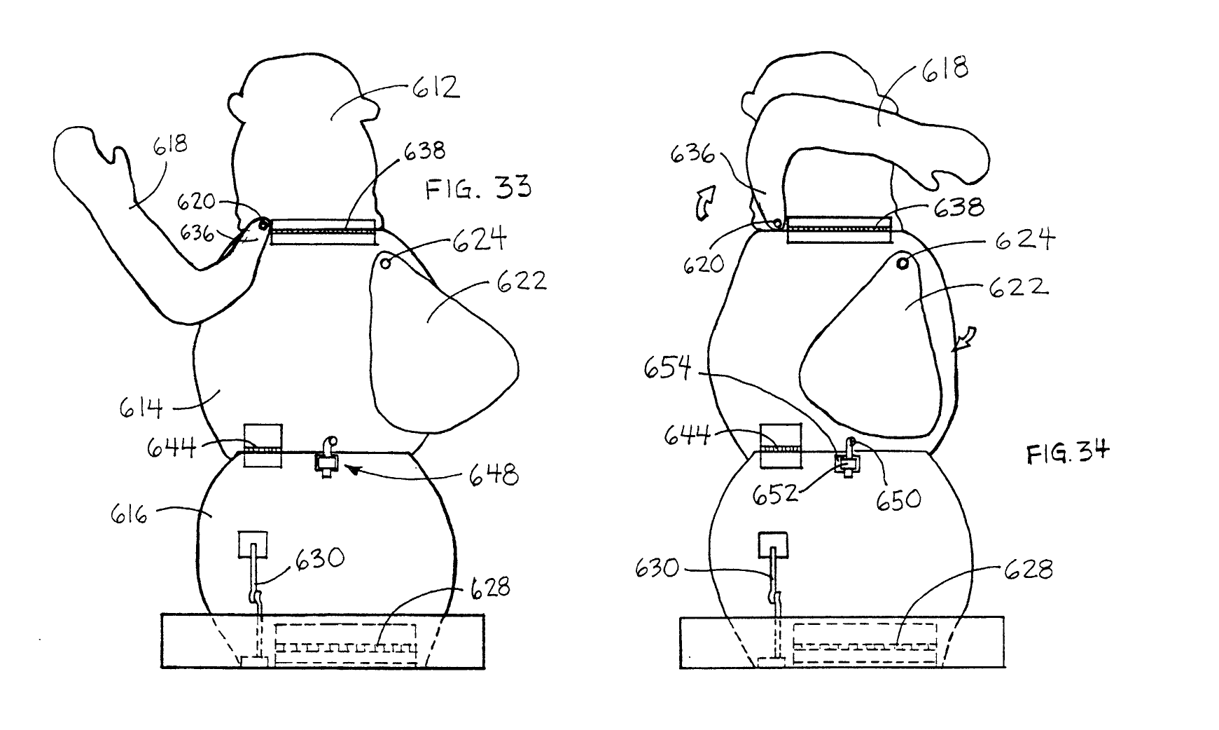

The first element that is adjusted to collapse the snowman FIG. 610 into a more compact form is the raised arm 618, which is rotated about pivot 620, and the lower arm 622, which is rotated about pivot 624, into positions that do not prevent folding of the head section 612 onto the body section 614 (see FIG. 36). In the erected state, the head section 612 is supported in an open, co-planar relationship with the body section 614 as a result of support provided by the uppermost extension 636 of the raised arm 618, which bridges the head section 612 and body section 614 and prevents folding along the upper hinge 638. When the raised arm 618 is rotated to remove the bridge support (FIG. 34), the head section 612 is free to rotate about upper hinge 638, allowing the head section 612 to be folded downwardly as shown in FIG. 35. To make the collapsed snowman FIG. 610 even smaller, the lowered arm 622 is rotated about pivot 624 as shown in FIG. 34 to tuck it in behind and create more overlap with the body section 614.

The next element that is adjusted to collapse the snowman FIG. 610 into a more compact form is the locking arm 630 which is bent inwardly to allow the base 626 to be rotated toward the leg section 616 about hinge 628.

The body section 614 is connected to the leg section 616 by hinge 644. An element for holding the snowman 610 erect that can be adjusted without disassembly to make it collapsible is provided between the body section 614 and leg section 616 by a pin and sleeve arrangement 648. A sleeve 652 affixed to the body section 614 extends through an opening 654 and, in the erect position, the sleeve 652 receives a holding pin 650. To allow the body section 614 to be folded down onto the leg section 616, the holding pin 650 is removed from the sleeve 652, so that the body section 614 is free to rotate about hinge 644, allowing sleeve 652 to pass through opening 654 as the body section 614 rotates toward the leg section 616. The hinge 644, when open, is offset and provides an open pocket therebetween such that the folded down head section 612 fits between the body section 614 and leg section 616 without interference.

In its collapsed state, the snowman FIG. 610 is essentially folded over onto itself in three (3) sections, resulting in a compact form of roughly one-third the size. In its collapsed form, the snowman 610 fits within the box 631, providing a form that is small and easily stored and transported. This is particularly advantageous because many figures can be similarly constructed and collapsed into the same size box so that a large number of figures can be compactly stored without requiring any disassembly.

While several embodiments of the present invention are disclosed herein, other equivalent embodiments representing other decorative figures are specifically contemplated and do not depart from the principles of the present invention. Other dimensions and arrangements of similar collapsible figures and displays are also specifically contemplated.

The collapsing of the snowman FIG. 610 into its own carrying box 631 is advantageous because the snowman, which is approximately five feet tall in its erected state, collapses into a box less than 2 feet square and approximately four inches deep. It is specifically contemplated that a large number of figures, similarly constructed, can be conveniently and efficiently stored. Further, interconnection between individual figures to create a large multi-figure display, is also specifically contemplated to be within the principles of the present invention.

I claim:

1. A collapsible decorative figure comprising:
at least two interconnected sections;
means for locking said at least two sections in to an erect state; and
means for adjusting said locking means to allow collapse of said at least two sections wherein no disassembly of said at least two interconnected sections, said locking means and said adjusting means is necessary to collapse said decorative figure.

2. The collapsible decorative figure of claim 1 further comprising means for supporting said collapsible decorative figure in a substantially vertical orientation in said erect state.

3. The collapsible decorative figure of claim 2 wherein said supporting means comprises a box for storage of said collapsible decorative figure.

4. The collapsible decorative figure of claim 2 wherein said at least two interconnected sections comprise three sections interconnected by hinges.

5. The collapsible decorative figure of claim 4 wherein said locking means comprise an arm bridging at least two of said three sections to prevent folding at said interconnecting hinges.

6. The collapsible decorative figure of claim 5 wherein said adjusting means comprise a pivot connection of said arm to one of said three sections.

7. The collapsible decorative figure of claim 1 wherein said locking means comprise pads overlapping hinge connections to prevent rotation about said hinges.

8. The collapsible decorative figure of claim 7 wherein said adjusting means comprise a slotted and slidable interconnection of said pads to one of said at least two interconnected sections.

9. The collapsible decorative figure of claim 8 wherein said at least two interconnected sections comprise a head and neck section and a body section interconnected by a pivot and said adjustment means further comprises said pivot.

10. The collapsible decorative figure of claim 1 wherein said at least two interconnected sections comprise:
two sidewalls;
a front wall;
a rear wall;
a floor panel; and
interconnections between said two sidewalls, said front wall and said rear wall comprising hinges and pivots.

11. The collapsible decorative figure of claim 10 wherein:
said two sidewalls further comprise fixed lower sections having curvature on upper edges;
said front wall further comprises front sidewalls having defined decorative edges;
said rear wall further comprises rear sidewalls having decorative edges;
said front wall decorative edges and said rear wall decorative edges mate with said curvature such that a lid is provided.

12. The collapsible decorative figure of claim 11 wherein said two sidewalls further comprise collapsible upper sections affixed to interior sidewall panels, said interior sidewall panels being anchored to said floor panel by full length hinges.

13. The collapsible decorative figure of claim 12 further comprising runners attached to said floor panel by downward depending legs.

14. The collapsible decorative figure of claim 12 further comprising two false wheels depending from said floor panel.

15. A decorative display comprising:
at least two decorative figures, each said figure comprising at least two interconnected sections;
means for locking said at least two interconnected sections into an erect state;
means for adjusting said locking means to allow collapse of said at least two sections wherein no disassembly of said at least two interconnected sections, said locking means and said adjusting means is necessary to collapse said decorative figures; and
a storage box formed by collapsing one of said at least two decorative figures, said storage box having a cavity defined therein such that other of said at least two decorative figures fit within said cavity.
